(19) United States
(12) Patent Application Publication
(10) Pub. No.: US 2005/0109738 A1
(43) Pub. Date: May 26, 2005

(54) Color coding of plasma arc torch parts and part sets

(76) Inventors: Roger W. Hewett, Plainfield, NH (US); Robert S. Brown, New London, NH (US); Matthew T. Cummins, Canaan, NH (US); Kevin D. Horner-Richardson, Cornish, NH (US)

Correspondence Address: HARNESS, DICKEY, & PIERCE, P.L.C, 7700 BONHOMME, STE 400, ST. LOUIS, MO, 63105, US

(21) Appl. No.: 10/719,328

(22) Filed: Nov. 21, 2003

(51) Int. Cl. B23K 10/00

(52) U.S. Cl. 219/121.48

(57) ABSTRACT

A series of replacement parts for use in a plasma arc torch is provided, wherein the parts have a color indicia and are adapted for use at different operating parameter values. Each part in the series has a color indicia formed on the part with a different color identifying the particular value of the operating parameter at which the part is adapted to operate. In another form, each part in the series is packaged in a package with a different color indicia identifying the particular value of the operating parameter at which the part is adapted to operate. Additionally, methods of packaging, applying the color indicia, selecting a package or part, and specifying a package or part are provided by the present invention.

### FIELD OF THE INVENTION

The present invention relates generally to plasma arc torches and more particularly to devices and methods for identifying and selecting replacement parts for use in plasma arc torches.

### BACKGROUND OF THE INVENTION

Plasma arc torches, also known as electric arc torches, are commonly used for cutting, marking, gouging, and welding metal workpieces by directing a high energy plasma stream consisting of ionized gas particles toward the workpiece. In a typical plasma arc torch, the gas to be ionized is supplied to a distal end of the plasma arc torch and flows past an electrode before exiting through an orifice in the tip, or nozzle, of the plasma arc torch. The electrode has a relatively negative potential and operates as a cathode. Conversely, the plasma arc torch tip constitutes a relatively positive potential and operates as an anode. Further, the electrode is in a spaced relationship with the tip, thereby creating a gap, at the distal end of the plasma arc torch. In operation, a pilot arc is created in the gap between the electrode and the tip, which heats and subsequently ionizes the gas. The ionized gas is blown out of the plasma arc torch and appears as a plasma stream that extends distally off the tip. As the distal end of the plasma-arc torch is moved to a position close to the workpiece, the arc jumps or transfers from the plasma arc torch tip to the workpiece because the impedance of the workpiece to ground is lower than the impedance of the plasma arc torch tip to ground. Accordingly, the workpiece serves as the anode, and the plasma arc torch is operated in a “transferred arc” mode.

To operate a plasma arc torch, an operator typically begins by setting certain operating parameters based on the workpiece material (type and thickness) and operating mode, e.g., cutting, gouging, and marking, among others. These operating parameters may include, but are not limited to, the amperage, starting method, gas type(s), and gas flow rate(s) of the plasma arc torch. Once the operator selects the proper levels for the operating parameters, the operator then ensures that the consumable components, or other replacement parts, rated for those levels are properly installed within the plasma arc torch. As used herein, replacement parts should be construed to include both consumable components and other components of the plasma arc torch that are not replaced as frequently as a consumable component. Accordingly, use of the terms “consumable components” or “components” should not be construed as limiting the scope of the present invention.

For example, the operator typically utilizes one or more of the following consumable components when operating the plasma arc torch: a tip, an electrode, a gas distributor, a shield cup, and/or a shield cap. Exemplary assembly and operation of a plasma arc torch is shown and described in U.S. Pat. No. 6,163,008, which is commonly assigned with the present application and the contents of which are incorporated herein by reference in their entirety. Once the consumable components are properly installed and the operating parameters set, one of two methods is typically used for initiating the pilot arc between the electrode and the tip. In the first method, commonly referred to as a “high frequency” or “high voltage” start, a high potential is applied across the electrode and the tip sufficient to create an arc in the gap between the electrode and the tip. Accordingly, the first method is also referred to as a “non-contact” start, since the electrode and the tip do not make physical contact to generate the pilot arc. In the second method, commonly referred to as a “contact start,” the electrode and the tip are brought into contact and are gradually separated, thereby drawing an arc between the electrode and the tip. The contact start method thus allows an arc to be initiated at much lower potentials since the distance between the electrode and the tip is much smaller.

Over time, the severe thermal environment created by the arc and plasma causes degradation, or consumption of the tip and the electrode in particular. Similarly, the shield cup experiences distortion caused by heat reflected from the work piece. Additionally, spattering from the workpiece may strike the exposed components, (e.g. the shield cup, the shield cap, and the tip), thereby causing additional deleterious heating.

Moreover, electrical conduction through the electrode and other conductive components during operation causes heating internal to the plasma arc torch. Combined with heat conducted from the arc, the electrical heating affects other internal components such as the gas distributor. Accordingly, the gas distributor is subject to heat-induced wear. Eventually, one or more components wear or deform beyond an allowable tolerance thereby giving rise to poor quality cuts (e.g., excessive dross build up on the bottom of the workpiece). Thus, several components within the plasma arc torch require replacement due to a variety of harsh operating conditions.

In the meantime, the plasma not only melts the workpiece where the cut is being made, but the plasma also vaporizes a fraction of the molten metal. The resulting metal fumes, in turn, tend to travel to the exposed components, thereby resulting in possible contamination. Additionally, the gas supply may be carrying other contaminants into the torch head. For instance, the gas may have entrained moisture, lubricants (e.g., from a compressed air system), particulates, and other residue from the gas supply. Additionally, skin oils, grease, dirt, and other contaminants could also have been deposited on the components of the plasma arc torch during assembly. These materials, with time and heat, may chemically attack the components of the plasma arc torch. Moreover, if two components move relative to one another, then the contaminants can cause the two components to bind together.

Thus, with operation of the plasma arc torch, certain components tend to degrade (or be consumed) and accordingly require replacement. Should the operator select the incorrect replacement components, for example assembling an electrode into the plasma arc torch with an incorrect amperage rating, less than optimal performance can be expected. Consequences from assembling incorrect components into the plasma arc torch include improper gas flow, improper plasma stream control, reduced life of the consumables, and plasma arc torch malfunction or damage. As a result, a poor quality cut may require that the workpiece be scrapped. Moreover, each time a component of the plasma arc torch is replaced, another opportunity exists for an incorrect component to be assembled into the plasma arc torch. Thus, a need exists to increase the reliability of proper component selection when operating a plasma arc torch.

Recently, one plasma arc torch manufacturer has begun installing color coded o-rings on the electrode, swirl ring, and nozzle of some of their plasma arc torches to indicate the workpiece material and amperage rating of the assembled plasma arc torch. Besides increasing the part count of the plasma arc torch, the colored o-ring scheme suffers from a number of disadvantages. First, the o-rings may become separated from the component on which they were installed. As a result, the original difficulty of determining the rating of the component, now disassociated from the o-ring, arises once again. Worse still, an o-ring coded for one rating may be removed from one component and placed on another component having a different rating than the o-ring indicates. Moreover, certain components may only be rated with respect to one operating parameter. Thus, the rating of these components, as indicated by the multiple parameter o-ring scheme, need not be constrained by irrelevant operating parameters. As a result, the o-ring scheme includes a needless multiplicity of o-ring color schemes, one scheme being required for each permutation of electrode, swirl ring, and nozzle ratings.

### SUMMARY OF THE INVENTION

In one preferred form, the present invention provides a series of replacement parts for a plasma arc torch, the series including parts adapted for use at different operating parameter values, wherein each part in the series has a color indicia formed on the part with a different color identifying the particular value of the operating parameter at which the part is adapted to operate. The replacement parts include, but are not limited to, electrodes, tips, gas distributors, shield caps, shield cups, start cartridges, torch heads, torch leads, lead parts, torch handles, adapters and adapter kits, and quick disconnects, among others. The operating parameters include, but are not limited to, amperage, starting method, gas type(s), gas flow rate(s), operating mode, and workpiece type and thickness, among others. Additionally, the color indicia includes, but is not limited to, a coating, a marking, and a non-functional accessory, among others.

In another form of the present invention, a series of replacement parts for a plasma arc torch is provided, wherein the replacement parts are packed in a package having a color indicia. The series includes parts adapted for use at different operating parameter values such that a package with a different color indicia identifies the particular value of the operating parameter at which the part is adapted to operate.

In yet another form of the present invention, a plasma arc torch comprising a plurality of replacement parts is provided. The parts are adapted for use at specific operating parameter values of the plasma arc torch, wherein each part has a color indicia formed on the part. Accordingly, the color identifies the particular value of the operating parameter at which each replacement part is adapted to operate.

The present invention also provides a series of replacement parts for a plasma arc torch, wherein the series including parts adapted for use at different operating amperages. Each part in the series has a color indicia formed on the part with a different color identifying the particular value of the amperage at which the part is adapted to operate.

In other forms of the present invention, methods are provided of identifying the values of an operating parameter at which replacement parts for a plasma arc torch are adapted to operate. The methods comprise the steps of packaging each part in a package with a color indicia, applying a color indicia to each part, selecting a part from a plurality of packaged parts or selecting a part from a plurality of parts, or specifying a plurality of packaged parts or specifying a plurality parts, based on different colors identifying the particular value of the operating parameter at which the parts or packaged parts are adapted to operate.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a manually operated plasma arc apparatus in accordance with the principles of the present invention;

FIG. 2 is a side view of an automated plasma arc apparatus in accordance with the principles of the present invention;

FIG. 3 is a side cross-sectional view of an exemplary high frequency start plasma arc torch comprising a plurality of replacement parts in accordance with the principles of the present invention;

FIG. 4 is a side cross-sectional view of a second exemplary plasma arc torch comprising a plurality of replacement parts in accordance with the principles of the present invention;

FIG. 5 is a side cross sectional view of a third exemplary plasma arc torch comprising a plurality of replacement parts in accordance with the principles of the present invention;

FIG. 6 is a perspective view of a series of replacement parts having a marking color indicia in accordance with the principles of the present invention;

FIG. 7 is a perspective view of another series of replacement parts having a coating color indicia in accordance with the principles of the present invention;

FIG. 8 is a perspective view of another series of replacement parts having a non-functional accessory color indicia in accordance with the principles of the present invention;

FIG. 9 is a front view of a series of replacement parts being packaged in packages with different color indicia in accordance with the principles of the present invention;

FIG. 10 is a side view of a series of adapter kits comprising a color indicia that corresponds with a power supply of a particular manufacturer; and

FIG. 11 is a perspective view of a laser cutting nozzle that may include the color indicia in accordance with the principles of the present invention.

Corresponding reference numerals indicate corresponding parts throughout the several views of the drawings.

### DETAILED DESCRIPTION OF THE PREFERRED EMBODIMENTS

The following description of the preferred embodiments is merely exemplary in nature and is in no way intended to limit the invention, its application, or uses.

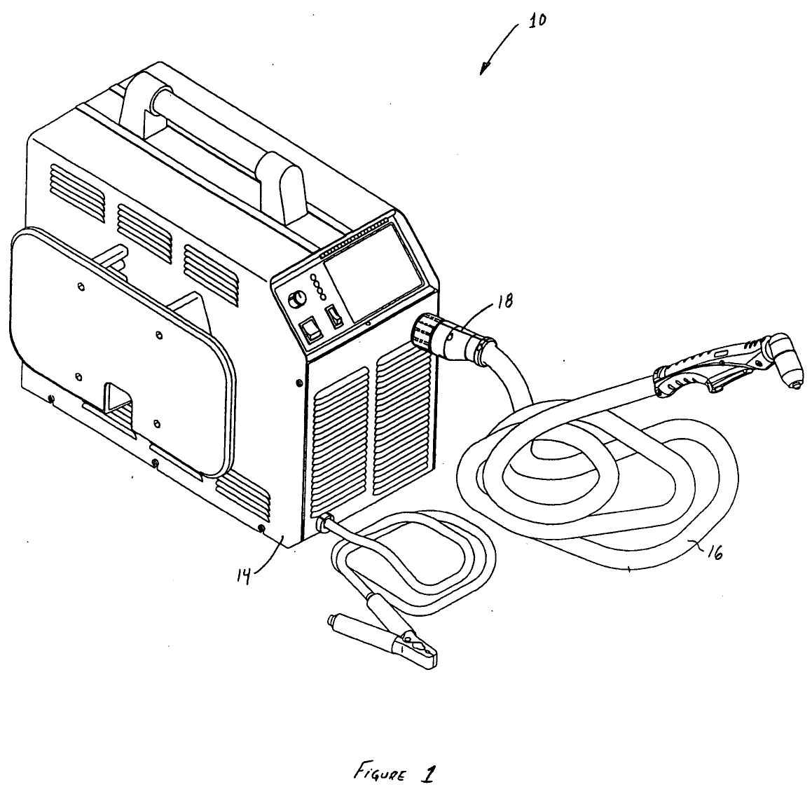

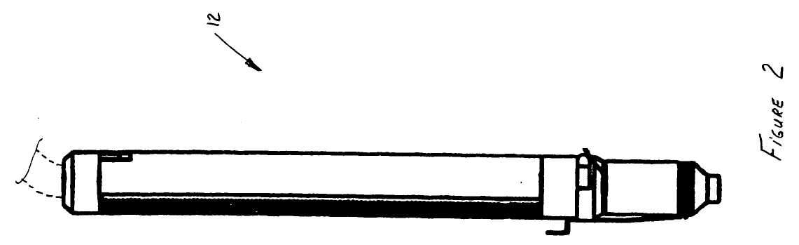

Referring to the drawings, color coded replacement parts according to the present invention are generally operable with either a manual plasma arc torch 10 or an automated plasma arc torch 12 as indicated in FIGS. 1 and 2, respectively. Generally, the manual plasma arc torch 10 is connected to a power supply 14 through a torch lead 16, which may be available in a variety of lengths according to a specific application. As further shown, the torch lead 16 is connected to the power supply 14 using a quick disconnect 18, although other adapters and connectors may also be used while remaining within the scope of the present invention. In operation, the power supply 14 provides both gas and electric power, which flow through the torch lead 16, to the plasma arc torch 10. The automated plasma arc torch 12 operates similarly with a power supply and torch lead, which are not illustrated herein for purposes of clarity.

As used herein, a plasma arc torch, whether operated manually or automated, should be construed by those skilled in the art to be an apparatus that generates or uses plasma for cutting, welding, spraying, gouging, or marking operations, among others. Accordingly, the specific reference to plasma arc cutting torches, plasma arc torches, or manually operated plasma arc torches herein should not be construed as limiting the scope of the present invention. Additionally, the present invention may also be employed with other torches that are not specifically plasma, which include but are not limited to, MIG (metal inert gas), TIG (tungsten inert gas), or gas welding and cutting. Furthermore, the specific reference to providing gas to a plasma arc torch or other torch should not be construed as limiting the scope of the present invention, such that other fluids, e.g. liquids, or solids such as powder or wire for spraying operations, may also be provided to the plasma arc torch in accordance with the teachings of the present invention.

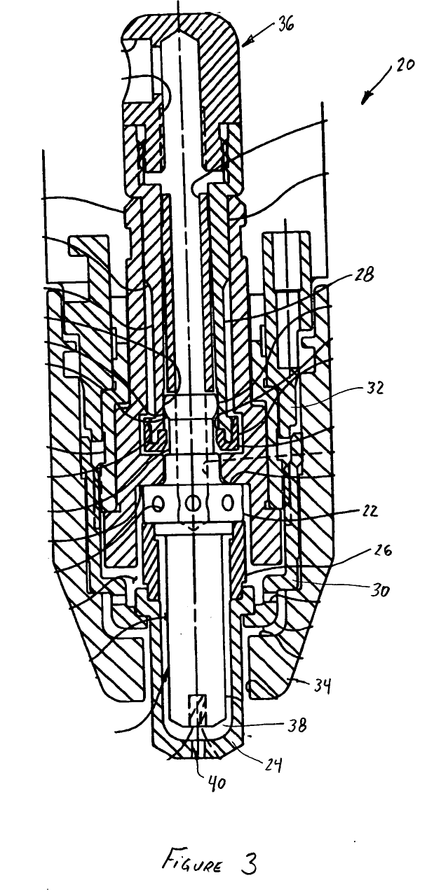

Referring now to FIG. 3, an exemplary high frequency start plasma arc torch according to the present invention is illustrated and generally indicated by reference numeral 20. As shown, the plasma arc torch 20 comprises a plurality of components that include, but are not limited to, an electrode 22, a tip 24 spaced distally from the electrode 22, and a gas distributor 26 disposed between the tip 24 and the electrode 22. The electrode 22 is in contact with a cathode body 28 to form the cathodic, or negative potential side of the power supply, and the tip 24 is in contact with a shield cup liner 30, which in turn is in contact with an anode body 32 to form the anodic, or positive potential side of the power supply. As further shown, a shield cup 34 secures and generally positions the aforementioned components to a torch head 36. In operation, a pilot arc is formed in a chamber 38, between the electrode 22 and the tip 24, and a gas is supplied to the chamber 38 through the gas distributor 26. Once the gas enters the chamber 38, the arc ionizes the gas, which forms a plasma stream that exits through an exit orifice 40 formed in the tip 24. Detailed operation of the plasma arc torch 20, along with additional components not discussed herein for purposes of clarity, is described in U.S. Pat. No. 6,163,008, which is commonly assigned with the present application and the contents of which are incorporated herein by reference in their entirety.

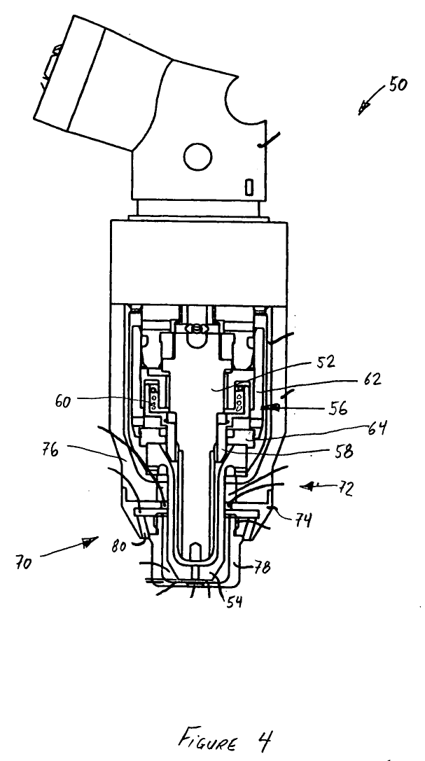

Referring now to FIG. 4, an exemplary contact start plasma arc torch is illustrated and generally indicated by reference numeral 50. As shown, the plasma arc torch 50 includes an electrode 52 and a tip 54 similar to the plasma arc torch 20 previously described, however, a start cartridge 56 is disposed between the electrode 52 and the tip 54. The start cartridge 56 comprises an initiator 58 and a coil spring 60 housed within a cartridge body 62 and a tip seat 64. Accordingly, the start cartridge 56 is preferably a single replaceable consumable component. Additionally, the start cartridge 56 as shown is preferably employed with a contact start plasma arc torch, however, the start cartridge 56 may also be employed with a high frequency start plasma arc torch such that a single start cartridge is used for both high frequency and contact start modes. Operation of the start cartridge 56 for both contact start and high frequency start modes is described in greater detail in co-pending application Ser. No.10/083,029, titled “Dual Mode Plasma Arc Torch,” filed on Feb. 26, 2002, which is commonly assigned with the present application and the contents of which are incorporated herein by reference in their entirety. Thus, additional components described therein may also be employed with the color coding system while remaining within the scope of the present invention.

As further shown, the plasma arc torch 50 also comprises a vented shield system 70 disposed at a distal end portion 72. The vented shield system 70 includes a vented retainer 74 secured to a shield cup body 76, and a shield cap 78 secured to the vented retainer 74. In operation, a portion of the secondary gas is directed through vent passageways 80 formed in the vented retainer 74 to direct a flow of vent gas toward the shield cap 78 for improved cooling. The shield cap 78 as shown is a mechanized cap used for mechanized cutting operations, however, other shield caps such as drag caps, gouging caps, and deflector caps, among others, may also be employed while remaining within the scope of the present invention. Further detail regarding the vented shield system 70 is shown and described in co-pending application Ser. No. 10/376,688, titled “Vented Shield System For a Plasma Arc Torch,” filed on Feb. 27, 2003, which is commonly assigned with the present application and the contents of which are incorporated herein by reference in their entirety. Thus, additional components described therein may also be employed with the color coding system while remaining within the scope of the present invention.

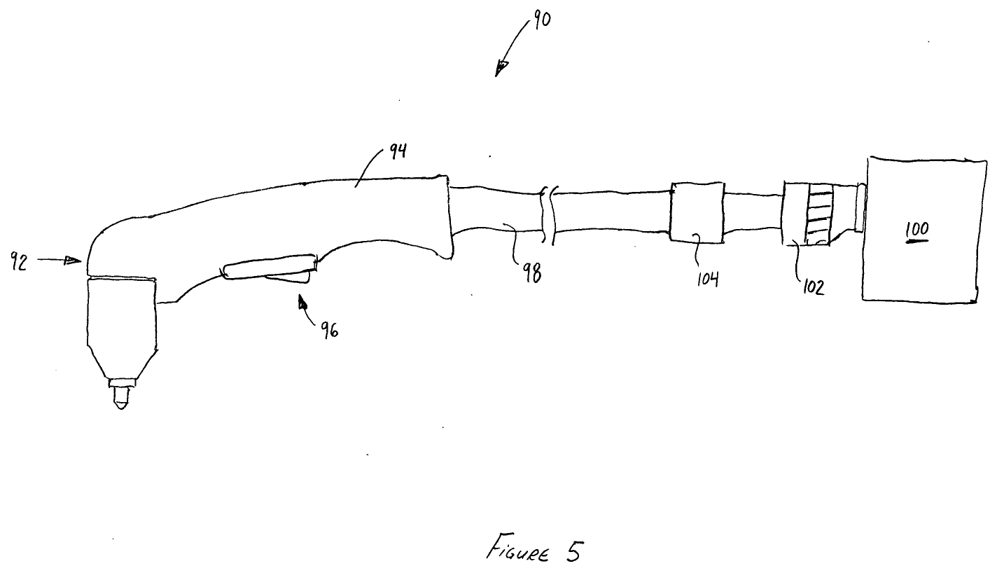

Yet another plasma arc torch as shown in FIG. 5 is illustrated and generally indicated by reference numeral 90. In addition to a torch head 92 and other consumable components (not shown) as previously described, the plasma arc torch 90 comprises a torch handle 94 and a trigger system 96 that activates the flow of gas and electric power. Further, the plasma arc torch 90 includes a torch lead 98 that connects the torch head 92 to a power supply 100. The torch lead 98 may be connected to the power supply 100 using a quick disconnect 102, and the torch lead 98 may also be connected to the power supply 100 using an adapter kit 104, wherein the plasma arc torch 90 is adapted for use with power supplies from different manufacturers. Additional detail regarding the plasma arc torch 90 is shown and described in the following co-pending applications, which are commonly assigned with the present application and the contents of which are incorporated herein by reference in their entirety: Ser. No. 10/083,194, titled “Modular Plasma Arc Torch,” filed on Feb. 26, 2002; Ser. No. 10/083,219, titled “Plasma Arc Torch Trigger System,” filed on Feb. 26, 2002; and Ser. No. 10/052,364, titled “Plasma Arc Torch Quick Disconnect,” filed on Nov. 9, 2001. Thus, additional components described therein may also be employed with the color coding system while remaining within the scope of the present invention. Moreover, the color coding system may be applied to any component of a plasma arc torch known in the art while remaining within the scope of the present invention. Accordingly, the components as shown and described herein should not be construed as limiting the scope of the present invention.

Over time, many of the replacement parts shown and described above are consumed or degraded during continued operation of the plasma arc torches 20, 50, and 90. Additionally, changes in a specific operating parameter such as operating amperage may necessitate replacement of one, or more, of the replacement parts. As the degradation worsens, the performance of the plasma arc torch also degrades and the quality of the workpiece being cut, or otherwise modified, correspondingly degrades. Accordingly, an operator must select an appropriate replacement part from among a variety of choices throughout operation of the plasma arc torch. However, selection of the proper replacement part can often become challenging depending on the particular operating environment.

Because the differences in replacement parts associated with the different levels of operating parameters may not be immediately evident, a quick and reliable method of identifying the ratings, or which operating parameter the replacement part is adapted for use with, of two or more similar replacement parts is provided by the present invention. Accordingly, a system is provided to associate the replacement parts of a plasma arc torch with the specific operating parameters of the plasma arc torch. More particularly, the present invention provides a system of color coding the replacement parts, or packaging therefor, to indicate which operating parameters of the plasma arc torch the replacement parts are intended for use.

The color coding is based on the operating parameters which may include, but are not limited to, amperage, starting method, gas type(s), gas flow rate(s), operating mode, material type of the replacement part(s), and workpiece thickness and material type. The starting method may be either contact or high frequency start, and the operating mode may be either cutting, marking, gouging, spraying, or welding, among others. With spraying, additional operating modes include transferred arc and nontransferred arc, and dense versus porous coating, among others. Further, the material type of the replacement part may include, by way of example, copper or tungsten alloys for the electrode. The operating parameters as listed and described herein are not intended to limit the scope of the present invention, and therefore, other operating parameters as known in the art may also be incorporated with the color coding system while remaining within the scope of the present invention.

To illustrate the color coding system according to the present invention, only one replacement part, namely, an electrode, is illustrated and described herein. It should be understood that the color coding system may also be applied to other replacement parts as previously described while remaining within the scope of the present invention. Furthermore, the color indicia used with the replacement parts generally include a marking that is formed into the replacement part, a coating that is applied over at least a portion of the replacement part, or a non-functional accessory that is removed prior to operation of the replacement part.

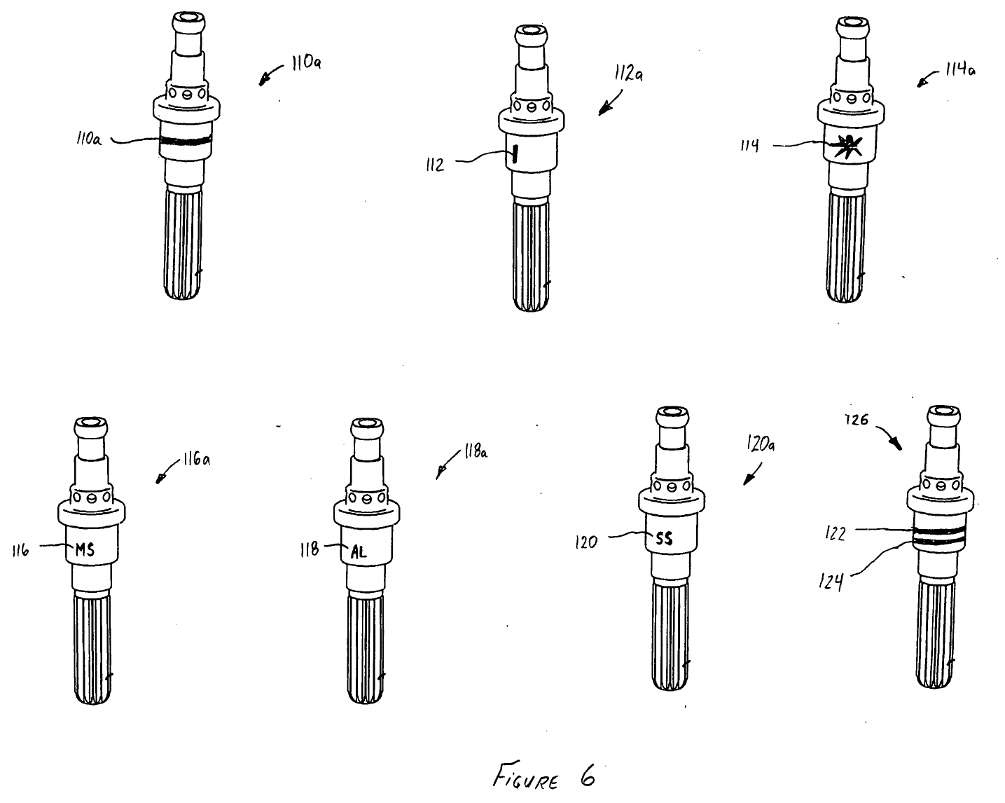

Referring now to FIG. 6, a series of replacement parts, namely electrodes, are shown with different markings. As shown, the markings comprise an annular groove 110 formed around an electrode 110a, a notch 112 formed into an electrode 112a, a trademark or logo 114 formed into an electrode 114a. The markings also comprise a series of letters 116, 118, and 120, formed into electrodes 116a, 118a, and 120a. With the series of letters, the letters “MS” represent the workpiece material being mild steel, the letters “AL” represent the workpiece material being aluminum, and the letters “SS” represent the workpiece material being stainless steel. Moreover, the markings further comprise a color that represents one or more of the operating parameters as described above. For example, the annular groove 110, the notch 112, the logo 114, or the series of letters 116, 118, and 120 may be colored yellow for 40 amps, blue for 50 amps, and red for 80 amps. Thus, the electrode having a “MS” marking in yellow is for use when cutting mild steel at 40 amps. Accordingly, an operator can more easily identify the proper replacement part through use of the color coded markings. It should also be understood that various configurations and colors of the markings shown herein are exemplary and are not intended to limit the scope of the present invention. Different colors may be assigned to different operating parameters as desired, depending on the particular application.

In further accordance with the principles of the present invention, more than one color indicia may be used with the replacement parts to indicate more than one operating parameter. For example, two annular grooves 122 and 124 may be formed into electrode 126 to indicate both operating amperage and start method. As shown, groove 122 is yellow for 40 amps, and groove 124 is orange for contact start. However, other color combinations that correspond with different operating parameters may also be employed while remaining within the scope of the present invention.

The markings as shown and described herein may be formed into the replacement parts using a variety of manufacturing methods known in the art. For example, the markings may be punched, roll formed, etched, scribed, or laser marked according to the principles of the present invention.

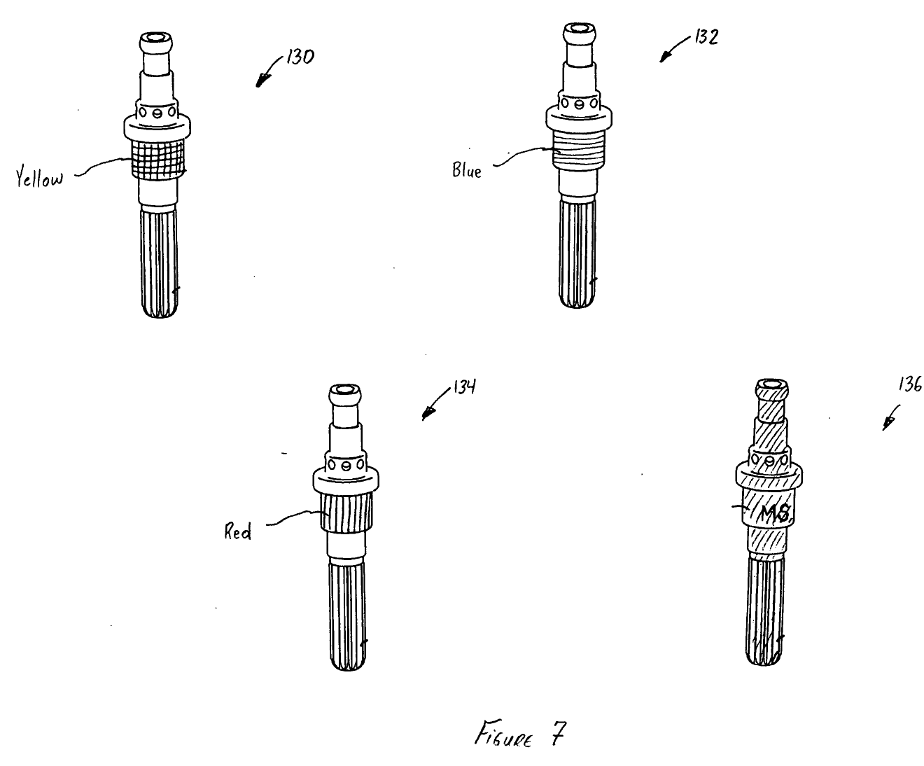

Yet another color indicia is shown in FIG. 7, wherein the series of replacement parts comprise a coating over at least a portion of each part. The coating defines a color, wherein for example, electrode 130 is yellow for 40 amps, electrode 132 is blue for 50 amps, and electrode 134 is red for 80 amps. Further, the coating may cover a portion of the replacement part, or the coating may cover the entire replacement part as shown by electrode 136. Additionally, the coatings are preferably applied to the replacement parts using a dye, a paint, an oxide coating, or an ink. However, other methods of applying a coating may also be employed while remaining within the scope of the present invention. In another form, the markings as described above such as “MS,” “AL,” or “SS” may be applied over the coating by way of stamping or masking, which is illustrated on electrode 136 with “MS.” Therefore, the electrode is colored and the marking is not colored, although the marking could comprise another color to define yet another value of an operating parameter.

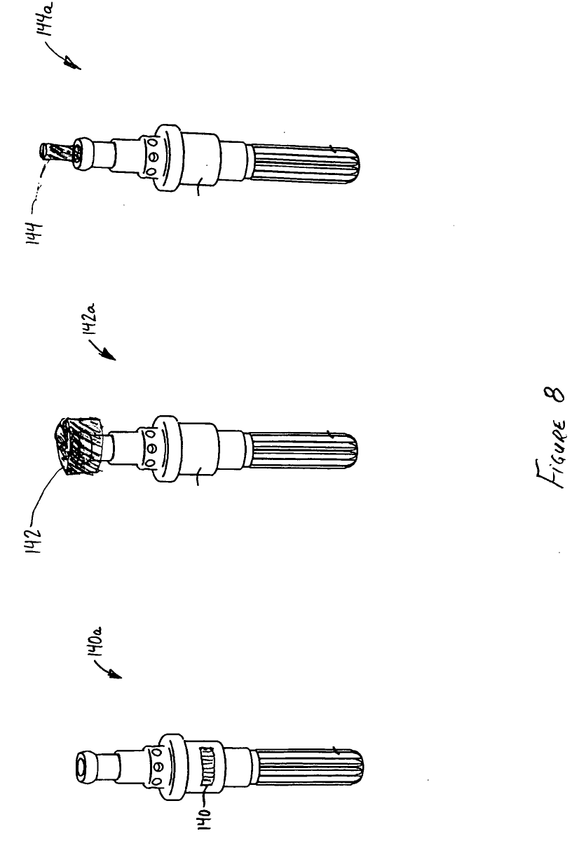

Referring now to FIG. 8, another color indicia according to the present invention is shown as a non-functional accessory attached to the replacement part, which must be removed prior to operation. As shown, the non-functional accessory may be a label 140 applied to electrode 140a, a cap 142 attached to electrode 142a, or a plug 144 attached to electrode 144a. Similarly, the non-functional accessories define a color as previously described, wherein for example, the accessories 140, 142, and 144 are yellow for 40 amps. Of course, different colors may be assigned to different operating parameters as desired, depending on the particular application, and the embodiments herein should not be construed as limiting the scope of the present invention.

With the marking and coating color indicia as described herein, it should be noted that the color indicia are preferably formed into or applied to the replacement parts such that operation of the plasma arc torch is not inhibited. For example, preferred locations of the various color indicia include surfaces where the indicia neither interferes with geometric fit or electric conduction between components.

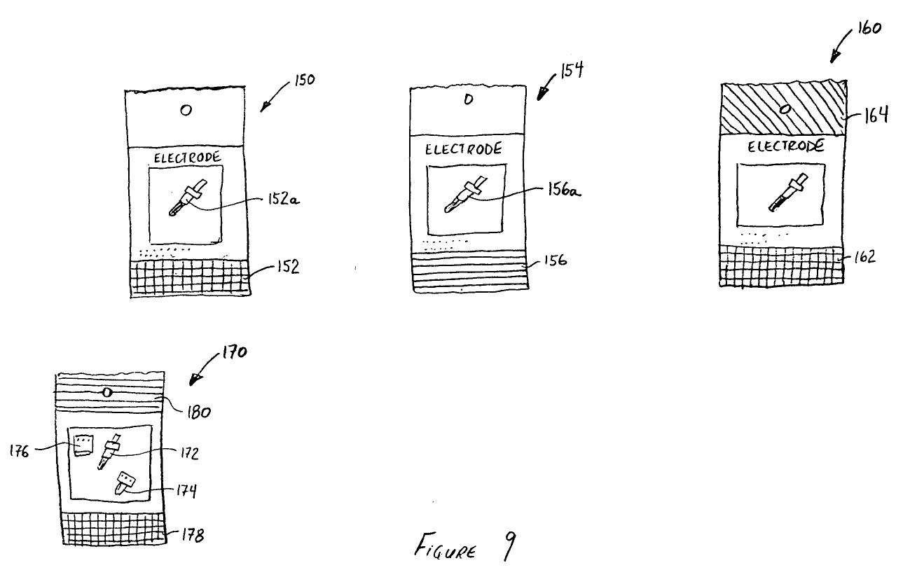

In yet another form as shown in FIG. 9, the present invention provides a package for a series of replacement parts for a plasma arc torch, wherein the package has a different color indicia identifying the particular value of the operating parameter at which the replacement part is adapted to operate. As shown, a package 150 containing a replacement component includes the color indicia 152 on the package. The color indicia 152 indicates which value of the operating parameter that the electrode 152a is adapted to operate. For example, the color indicia 152 is yellow as shown to indicate that the electrode 152a is adapted to operate at 40 amps. Similarly, package 154 includes color indicia 156 (blue) to indicate that the electrode 156a is adapted to operate at 50 amps. Alternately, more than one color indicia may be applied to the package as shown by package 160. Package 160 includes color indicia 162 (yellow) to indicate operating amps and color indicia 164 (green) to indicate starting method. The packages 150, 154, and 160 are preferably a bag as shown, however, other packaging devices such as a box that at least partially encloses the replacement part may also be employed while remaining within the scope of the present invention.

As further shown, a package 170 includes a plurality of replacement parts, namely an electrode 172, a tip 174, and a start cartridge 176, in the form of a kit. The package 170 includes color indicia 178 (yellow) and 180 (blue), wherein 178 indicates the operating amps and 180 indicates starting method. Accordingly, more than one replacement part may be packaged within a package that includes more than one color indicia corresponding to different operating parameters.

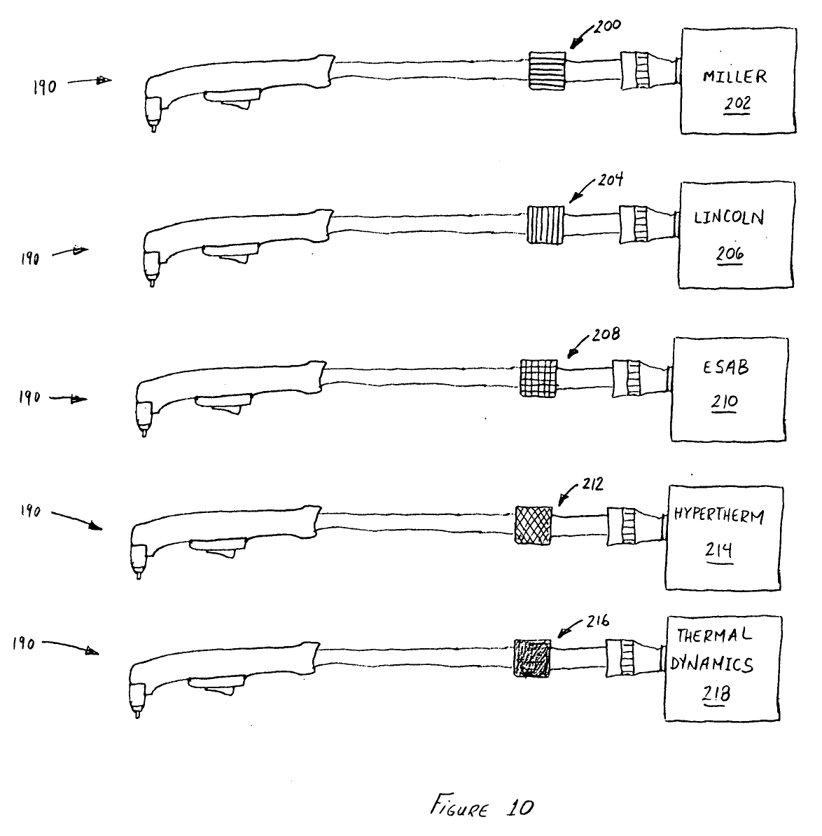

Referring now to FIG. 10, the color indicia may also be applied to replacements parts according to a particular manufacturer. As shown, adapter kits that connect a plasma arc torch 190 to power supplies of different manufacturers are color coded according to a color associated with that particular manufacturer. For example, adapter kit 200 is blue for use with a Miller® power supply 202. Similarly, adapter kit 204 is red for use with a Lincoln® power supply 206, adapter kit 208 is yellow for use with an ESAB® power supply 210, adapter kit 212 is orange for use with a Hypertherm® power supply 214, and adapter kit 216 is black for use with a Thermal Dynamics power supply 218. Additionally, other replacement parts such as electrodes, tip, and shield cups, among others as previously disclosed, may also be color coded according to a color associated with a particular manufacturer while remaining within the scope of the present invention.

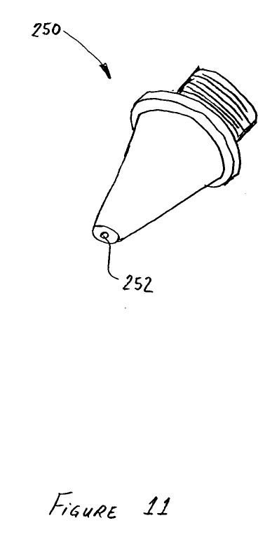

As shown in FIG. 11, replacement parts for other types of torches may incorporate the color coding system according to the teachings of the present invention. These replacement parts may include, by way of example, a nozzle 250 for laser cutting applications. As shown, the nozzle 250 comprises an orifice 252, which typically varies among a narrow range of diameters depending on the type of material being cut. For example, the diameter of the orifice 252 can include diameters of about 1.0 mm, 1.2 mm, 1.3 mm, and 1.5 mm. Therefore, since the difference between these diameters would be difficult if not impossible to identify by visual inspection, the color coding system according to the present invention would allow the proper nozzle to be quickly identified. Additionally, replacement parts for torches such as those disclosed in U.S. Pat. Nos. 5,440,100, 5,916,465, and 5,407,348, which are incorporated herein by reference in their entirety, may also be color coded as described herein while remaining within the scope of the present invention. For example, welding nozzles and tips are sized for different material thicknesses and wire diameters and could be color coded to more easily identify the proper replacement nozzles and tips in accordance with the teachings of the present invention.

Accordingly, the present invention provides a color coding system to associate the replacement parts of a plasma arc torch with a variety of operating parameters thereof. A result, an operator is able to more quickly and reliably select the proper replacement part for use in the plasma arc torch. Because the present invention enables the operator to quickly and reliably select the correct replacement part for the desired operating parameter(s), efficiency of operations is improved. Thus, the present invention reduces scrap, rework, and other expenses associated with improper operation of a plasma arc torch through the use of improper replacement parts.

The description of the invention is merely exemplary in nature and, thus, variations that do not depart from the substance of the invention are intended to be within the scope of the invention. For example, the color indicia for replacement parts or packaging may be specified in an instruction manual, catalog, or operating manual, wherein the method of specifying the color indicia remains within the scope of the present invention. Such variations are not to be regarded as a departure from the spirit and scope of the invention.

1. A series of replacement parts for a plasma arc torch, the series including parts adapted for use at different operating parameter values, each part in the series having a color indicia formed on the part with a different color identifying the particular value of the operating parameter at which the part is adapted to operate.

2. The series of replacement parts according to claim 1, wherein the replacement parts are selected from a group consisting of electrodes, tips, nozzles, gas distributors, shield caps, shield cups, start cartridges, torch heads, torch leads, lead parts, torch handles, adapters, adapter kits, and quick disconnects.

3. The series of replacement parts according to claim 2, wherein the shield caps are selected from a group consisting of mechanized caps, drag caps, gouging caps, and deflecting caps.

4. The series of replacement parts according to claim 2, wherein the lead parts are selected from a group consisting of hoses, wiring, shield sheaths, strain reliefs, lead jackets, and connectors.

5. The series of replacement parts according to claim 2, wherein the color indicia for the replacement parts is based on use with a specific manufacturer and is selected from a group consisting of blue for Miller, red for Lincoln, yellow for ESAB, orange for Hypertherm, and black for Thermal Dynamics.

6. The series of replacement parts according to claim 1, wherein the operating parameter is selected from a group consisting of amperage, starting method, gas type, gas flow rate, operating mode, replacement part material type, workpiece thickness, and workpiece material type.

7. The series of replacement parts according to claim 1, wherein the color indicia is a coating on at least a portion of each replacement part.

8. The series of replacement parts according to claim 7 further comprising a marking selected from a group consisting of MS for mild steel, AL for aluminum, SS for stainless steel, and GP for general purpose.

9. The series of replacement parts according to claim 1, wherein the color indicia is a marking.

10. The series of replacement parts according to claim 9, wherein the marking is selected from a group consisting of MS for mild steel, AL for aluminum, SS for stainless steel, and GP for general purpose.

11. The series of replacement parts according to claim 10, wherein the MS, AL, and SS define a color corresponding to an operating amperage of the replacement part.

12. The series of replacement parts according to claim 9, wherein the marking is a logo or trademark.

13. A series of replacement parts for a plasma arc torch, the series including parts adapted for use at different operating parameter values, each part in the series being packaged in a package with a different color indicia identifying the particular value of the operating parameter at which the part is adapted to operate.

14. A plasma arc torch comprising a plurality of replacement parts, the parts being adapted for use at specific operating parameter values of the plasma arc torch, each part having a color indicia formed on the part, wherein the color identifies the particular value of the operating parameter at which the part is adapted to operate.

15. A series of replacement parts for a plasma arc torch, the series including parts adapted for use at different operating amperages, each part in the series having a color indicia formed on the part with a different color identifying the particular value of the amperage at which the part is adapted to operate.

16. A series of replacement parts for a torch, the series including parts adapted for use at different operating parameter values, each part in the series having a color indicia formed on the part with a different color identifying the particular value of the operating parameter at which the part is adapted to operate.

17. The series of replacement parts according to claim 16, wherein the torch is selected from a group consisting of plasma arc, MIG, TIG, gas, and laser.

18. The series of replacement parts according to claim 16, wherein the replacement parts are nozzles for laser cutting torches.

19. A method of identifying the values of an operating parameter at which replacement parts for a plasma arc torch are adapted to operate, the method comprising the step of packaging each part in a package with a color indicia with a different color identifying the particular value of the operating parameter at which the packaged part is adapted to operate.

20. A method of identifying the values of an operating parameter at which replacement parts for a plasma arc torch are adapted to operate, the method comprising the step of applying a color indicia to the part, with a different color identifying the particular value of the operating parameter at which the part is adapted to operate.

21. A method of selecting proper replacement parts for a plasma arc torch from a plurality of similarly appearing replacement parts adapted for use at different operating parameters, the method comprising the step of selecting a part from a plurality of packaged parts based on a color indicia corresponding to the desired operating parameter for the replacement part.

22. A method of selecting proper replacement parts for a plasma arc torch from a plurality of similarly appearing replacement parts adapted for use at different operating parameters, the method comprising the step of selecting a part from a plurality of parts based on a color indicia corresponding to the desired operating parameter for the replacement part.

23. A method of specifying proper replacement parts for a plasma arc torch from a plurality of similarly appearing replacement parts adapted for use at different operating parameters, the method comprising the step of specifying a plurality of packaged parts based on a color indicia on the package corresponding to the desired operating parameter for the replacement part.

24. A method of specifying proper replacement parts for a plasma arc torch from a plurality of similarly appearing replacement parts adapted for use at different operating parameters, the method comprising the step of specifying a plurality of parts based on a color indicia on the parts corresponding to the desired operating parameter for the replacement part.
